(19) United States
(12) Patent Application Publication
(10) Pub. No.: US 2007/0273661 A1
(43) Pub. Date: Nov. 29, 2007

(54) Input device with a page turning function

(75) Inventors: Kuo-Ping Yang, Taipei (TW); Ho-Hsin Liao, Taipei (TW); Shu-Hua Guo, Taipei (TW); I-Nan Wu, Taipei (TW); Chih-Long Chang, Taipei (TW); Chien-Liang Chiang, Taipei (TW); Kun-Yi Hua, Taipei (TW)

Correspondence Address: BACON & THOMAS, PLLC, 625 SLATERS LANE, FOURTH FLOOR, ALEXANDRIA, VA, 22314, US

(73) Assignee: KUO-PING YANG, Taipei (TW)

(21) Appl. No.: 11/486,276

(22) Filed: Jul. 14, 2006

(30) Foreign Application Priority Data
May 29, 2006 (TW) 095119065

(51) Int. Cl. G06F 3/041

(52) U.S. Cl. 345/173

(57) ABSTRACT

An input device with a page turning functionality is used with a set of communication cards, and includes a casing, a clip provided to hold the communication cards together, a processor, a touchpad, a memory, a speaker and a target page reminding device. When at least one communication block on a communication card is pressed, the processor generates a target page signal. The target page reminding device will remind a user to turn to the corresponding page according to the target page signal.

### BACKGROUND OF THE INVENTION

1. Field of the Invention

The present invention relates to an input device with a page turning functionality that may be used with a plurality of communication cards and a touchpad for learning and communication purposes.

2. Description of the Related Art

Input devices for learning and communication purposes that make use of a plurality of communication cards and a touchpad have been available for years; most of the users are children or slow learners, as indicated in U.S. Pat. No. 5,088,928. However, the communication cards frequently get mixed up, which is a source of inconvenience. The applicant of the present invention therefore invented U.S. Pat. No. 6,369,721. U.S. Pat. No. 6,369,721 utilizes a clip to neatly clip together one side of the plurality of communication cards. Yet, even with the clip, the users may still sometimes mix up the communication cards and become confused.

U.S. Pat. No. 6,369,721 utilizes the clip to fasten the communication cards together so that the communication cards can be turned like pages in a book, and the communication cards may be arranged for stepped learning. However, the prior art input device is unable to utilize communication cards that have a stepped learning format.

It is therefore desirable to provide an input device having a page turning functionality that may be used with a set of communication cards to mitigate and/or obviate the aforementioned problems.

### SUMMARY OF THE INVENTION

A main objective of the present invention is to provide an input device having a page turning functionality, which can remind the user to turn to the correct communication card.

In order to achieve the above-mentioned objective, input device with a page turning functionality is used with a set of communication cards, and includes a casing, a clip provided to hold the communication cards together, a processor, a touchpad, a memory, a speaker and a target page reminding device. When at least one communication block on a communication card is pressed, the processor generates a target page signal. The target page reminding device will remind a user to turn to the corresponding page according to the target page signal.

According to the embodiment, the present invention can further comprises recognition device for detecting the current communication card to obtain the corresponding page code of the current displayed communication card, so if the user did not turn to the communication card corresponding to the target page code signal, the processor generates an error signal to inform the user.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of the present invention.

FIG. 2 is a partial cut-away perspective view of the present invention.

FIG. 3 is a circuit diagram of the present invention.

FIG. 4 is a flow chart of an embodiment of the present invention.

FIGS. 5A, 5B and 5C show an embodiment of the communication cards according to the present invention.

FIG. 6 shows software program control commands corresponding to a Home page communication card.

FIG. 7 shows an embodiment for a fourth page communication card.

FIG. 8 shows a software program control command corresponding to the communication card of page 4.

### DETAILED DESCRIPTION OF THE PREFERRED EMBODIMENT

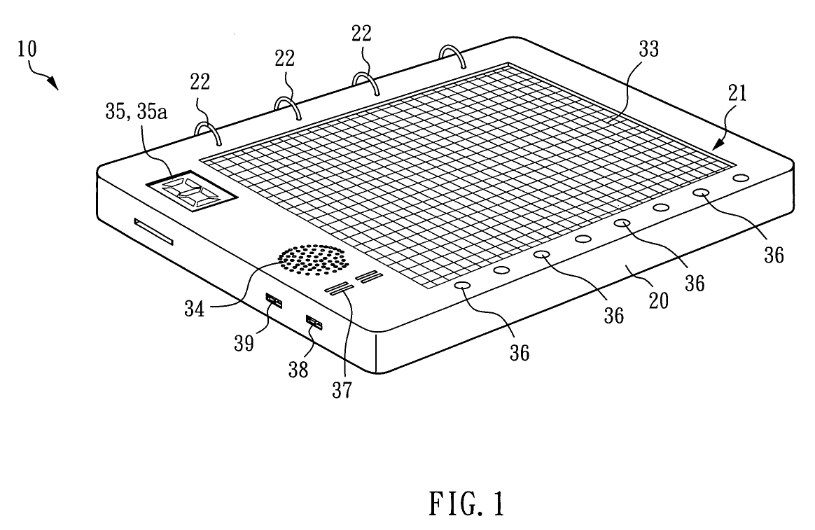

Please refer to FIGS. 1˜3. An input device page turning functionality capabilities 10 of the present invention has a casing 20, wherein the casing 20 has an operating panel 21 for accepting a plurality of communication cards 90. The input device 10 further includes a speaker 23 for audio output, and a microphone that is used for audio input. The communication card 90 may include different commands, text, or figures. Briefly, after the user presses the communication card 90, a touchpad 33 below the communication card 90 detects which area has been pressed and generates a correspond output (which is typically an audible sound).

This input device 10 for the communication card 90 and the touchpad 33 further comprises a processor 31, a memory 32 (for storing a system program, a software control program, audio data, etc.), a play/record switch 38, and a power switch 39. The play/record switch 38 is used to switch between a play function and a record function, so that the user may hear sounds from the speaker 34 by pressing the communication card 90, as well as record sounds into the memory 32 via the microphone 37 by pressing upon the communication card 90. In this embodiment, a swappable memory module 32a (such as an SD card, a CF card or the like) and a memory slot 23 are provided; the swappable memory module 32a may store related software control commands or audio data for the plurality of communication cards 90. Therefore, a set of communication cards 90 may have a corresponding swappable memory module 32a.

The casing 20 has a clip 22, which can neatly clip together the plurality of communication cards 90, so that the user may go through the communication cards 90 by placing them on the control panel. The above-mentioned structure and functionality are disclosed in U.S. Pat. No. 6,369,721, and do needs no further description.

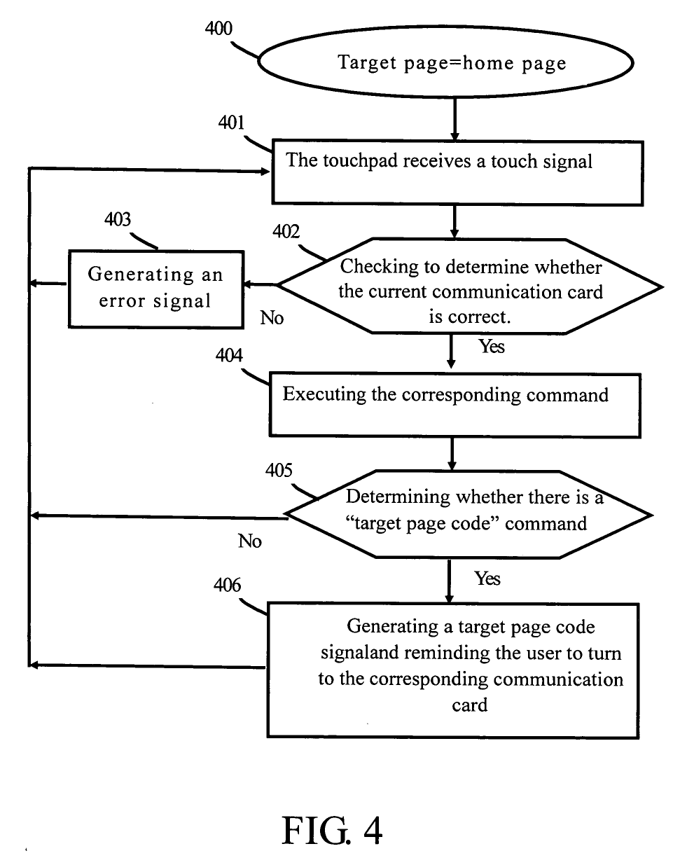

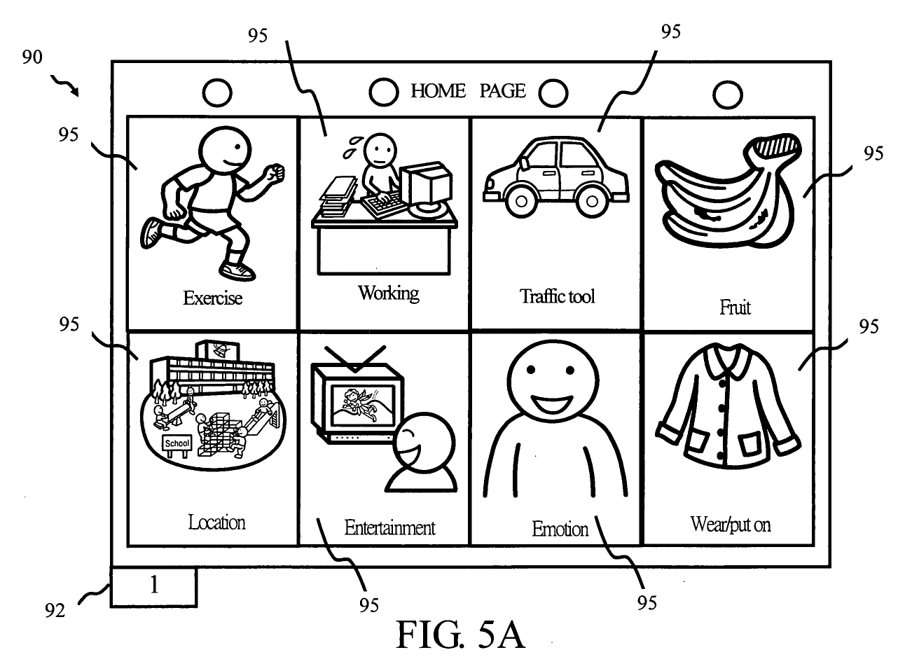

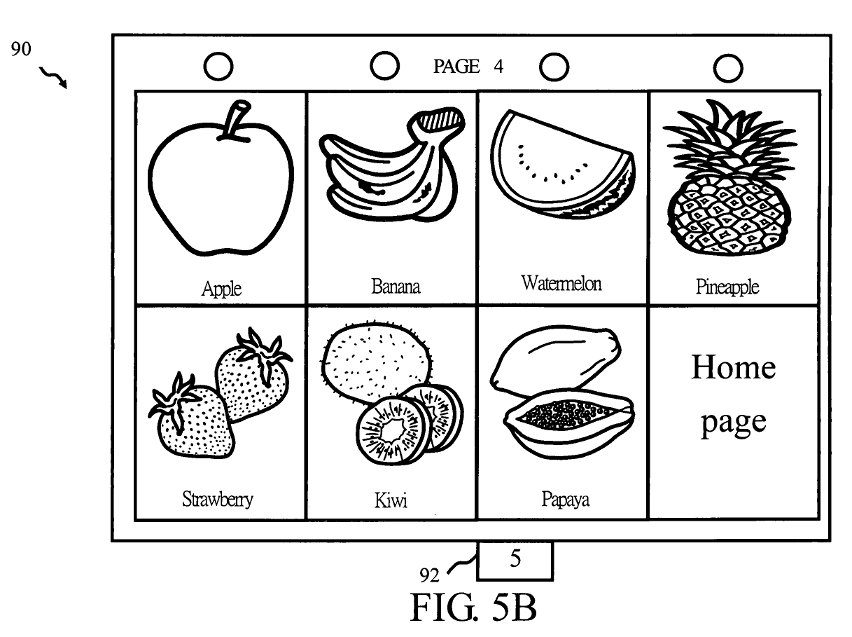

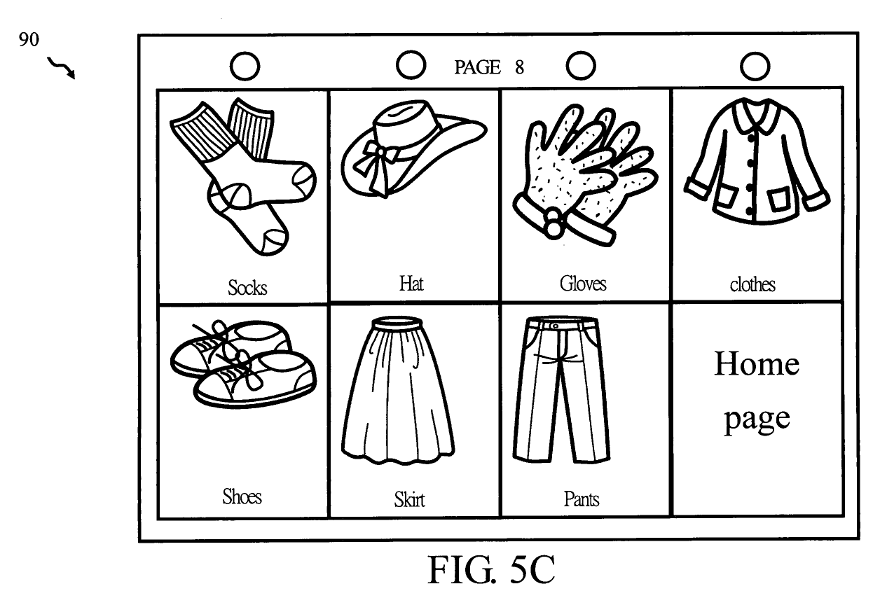

An objective of the present invention is to inform the user to turn to a particular communication card 90, and if the user turns to the wrong page he or she will be informed of that. In order to achieve the above mentioned objective, the embodiment of the present invention further comprises a target page reminding device 35 and a recognition device 36. Please refer to FIG. 4. FIG. 4 is a flow chart of an embodiment of the present invention. Reference is also drawn to FIGS. 5˜8 to understand the present invention:

### Step 400:

In this embodiment, there are nine communication cards 90. Each communication card 90 has a corresponding page code; for example, these page codes may be 0 (the Home page), 1, 2 . . . 8. Use of the communication cards 90 typically begins with page 0 (the Home page). In order to simplify the following description, in the following, “target page code” indicates a correct page number; for example, at the very beginning of use, the “target page code”=page 0 (the Home page).

The target page reminding device 35 is used to remind the user to turn to the target page code. The target page reminding device 35 in this embodiment is a target page reminding display 35a; for example, the target page reminding display 35a displays the page code using a 7 segment LED. Therefore, the target page reminding display 35a displays “0” at the beginning of use. The target page reminding device 35 may also utilize the speaker 34 to inform the user of the correct communication card 90 by way of an audible sound; therefore, there may be no need for the target page reminding display 35a.

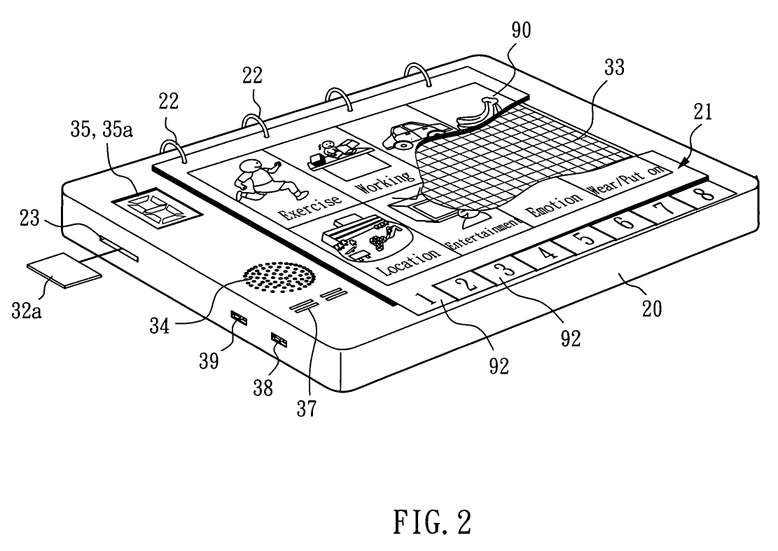

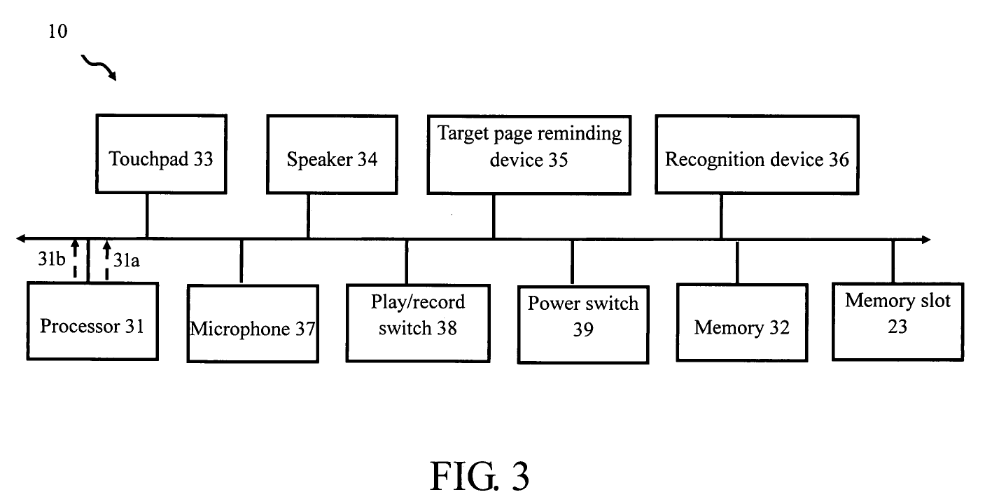

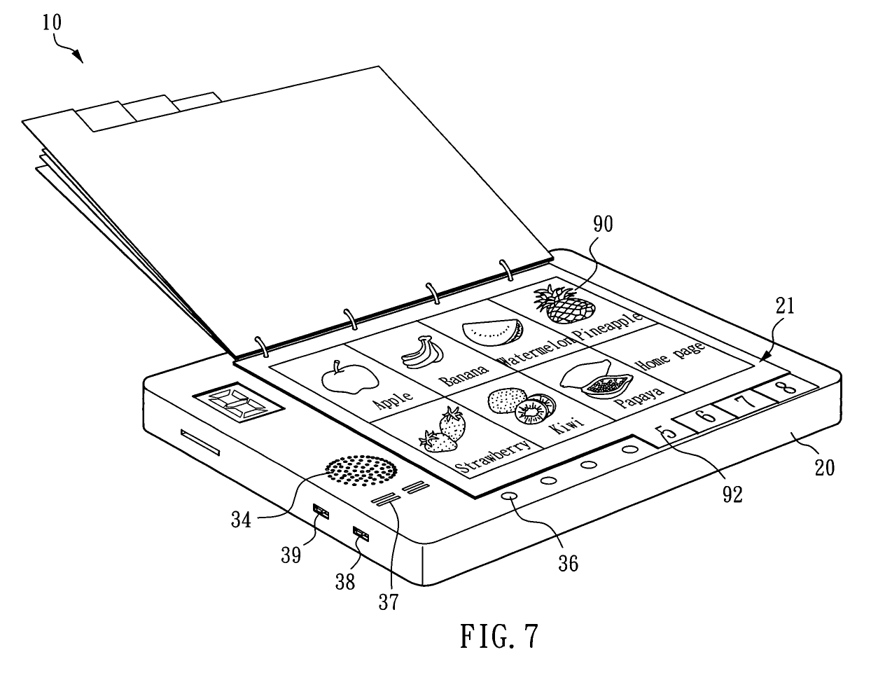

In this embodiment, most of communication cards 90 include a page code tag 92; for example, for the communication card 90 for page 0 (the Home page (FIG. 5A)), the page code tag 92 is printed with a “1”; the communication card 90 for page 4 (FIG. 5B), the page code tag 92 is printed with a “5; and the last communication card 90 (page 8, FIG. SC) has no page code tag 92. The design of this embodiment is used to help the user instinctively turn to the target page code. Please refer to FIG. 2, if the user wants to turn to the communication card 90 for page 4, he or she can directly grab the page code tag 92 printed with a “4” and turn the page page 4 will then be displayed as shown in FIG. 7.

### Step 401:

The touchpad 33 receives a touch signal.

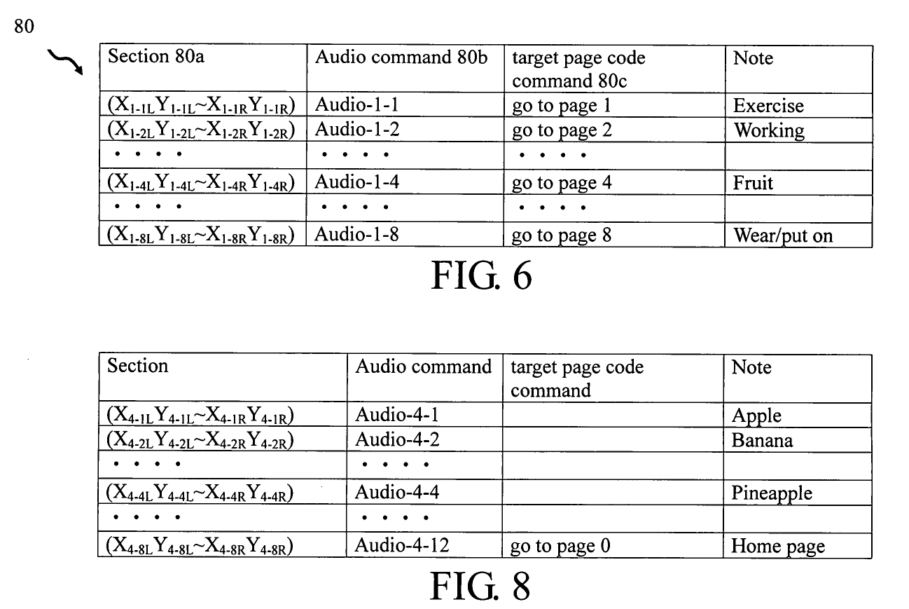

For example, the communication card 90 of page 0 (the Home page, FIG. 5A) includes eight communication blocks 95, and the user may press the communication block 95, which corresponds to “fruit”. Please refer to FIG. 6. FIG. 6 shows the software program control command corresponding 20 to the Home page communication card. The memory 32 or the memory 32a stores the software program control commands corresponding to each communication card 90. For example, in the software program control command 80 corresponding to the Home page communication card, a block section 80a records the blocks in each communication block 95; for example, if each communication block 95 is rectangular, the locations of the upper left corners and the lower right corners may be used to describe each block in the communication block 95. For example, with the communication card for the Home page, if the fourth communication block is “fruit” , the block section 80a records “(X_{1-4L}Y_{1-4L}˜X_{1-4R}Y_{1-4R})”, an audio command section 80b records a corresponding audio file Audio-1-4 to be played when the communication block 95 is pressed; and a target page code command section 80c records “go to page 4”. “Go to page 4” means that when the “fruit” communication block 95 is pressed, the user should turn to the communication card for page 4.

The technology utilized by the communication block 95 is a well known technology, and so needs no further description. However, the prior art input device does not have additional target page code information.

### Step 402:

Checking to determine whether the current communication card 90 is correct.

For example, when the device is turned on, the “target page code” is page 0 (the Home page), and the recognition device 36 detects whether the current displayed communication card is page 0 (the Home page). The recognition device 36 can be, for example, eight light detectors, to detect whether the page code tag 92 of each communication card 90 has covered any of the eight light detectors to identify the current communication card 90. In this embodiment, all eight page code tags 92 separately correspond to the position of the eight light detectors (as shown in FIG. 1). If all eight light detectors of the recognition device 36 are covered by the page code tags 92, this means the current displayed communication card 90 is page 0 (the Home page). If the very first four light detectors are not covered, this means the current displayed communication card 90 is page 4 (as shown in FIG. 7).

The recognition device 36 can therefore detect the current displayed communication card 90 to obtain the corresponding page code of the communication card 90 for comparison with the “target page code”.

For example, if the “target page code” is page 0 (the Home page), and the current displayed communication card 90 is also page 0 (the Home page), step 404 is executed. But if the current displayed communication card 90 is not page 0 (the Home page), step 403 is executed.

### Step 403:

Generating an error signal 31b.

For example, if the “target page code” is page 0 (the Home page), but the current displayed communication card 90 is not page 0 (the Home page), the processor 31 generates an error signal 31b. Then, the speaker 34 generates an error audio signal according to the error signal 31b. The error audio signal may be a pre-recorded in the memory 32, such as “please turn to page 0”, indicating that the page code of the current displayed communication card 90 is not the “target page code,” thus reminding the user to turn to the “target page code”.

Of course, the target page reminding display 35a may also generate an error information signal according to the error signal 31b. For example, the target page reminding display 35a may repetitively flash “Incorrect! Go to page 0”. The target page reminding display 35a may utilize an LCD or LED capable of displaying letters.

Since the currently-displayed communication card 90 is not the communication card 90 corresponding to the “target page code”, step 404 is not executed, and the currently-displayed communication card cannot be used, so that the user can not use the currently displayed communication card in a normal manner.

### Step 404:

Executing the corresponding command.

If, for example, the user presses communication block 95 for “fruit” on the communication card 90 for page 0 (the Home page), with reference to FIG. 6 and step 401, the audio file Audio-1-4 is played over the speaker 34.

### Step 405:

Determining whether there is a “target page code” command

By way of example, if the user presses communication block 95 for “fruit” on the communication card 90 of page 0 (the Home page), and with reference to FIG. 6 and step 401, since the corresponding target page code command section 80c of the communication block 95 of “fruit” stores “go to page 4”, step 406 is executed. If the corresponding target page code command section of the communication block 95 pressed by the user does not store a target page code command, the process returns to step 401 to wait for the user to touch the next communication card 90.

### Step 406:

For example, if the user presses communication block 95 for “fruit” on the communication card 90 of page 0 (the Home page), “target page code” changes from “0” to “4”, and the processor 31 generates a target page code signal 31a (for example, with information about page code “4”) to cause the target page reminding device 35 to remind the user to turn to the corresponding communication card based upon the target page code signal 31a; for example, the target page reminding display 35a may display “4”.

The following provides further explanation of the operational principles of the input device 10.

Please refer to FIG. 8. FIG. 8 shows the software program control command corresponding to the communication card of page 4, when the user turns to the communication card 90 for page 4 (as shown in FIG. 5B and FIG. 7).

If the user presses the communication block 95 for “apple” which is located in (X_{4-1L}Y_{4-1L}˜X_{4-1R}Y_{4-1R}) since the communication card 90 for page 4 matches the current “target page code”, step 404 is executed (playing the audio file Audio-4-1, such as pronouncing “apple” in English). Also, because the communication block 95 for “apple” has no corresponding target page code command, step 406 is not executed, which means the “target page code” remains “4”.

But, if the user presses the communication block 95 for “Home page” which is in (X_{4-8L}Y_{4-8L}˜X_{4-8R}Y_{4-8R}), since the corresponding target page code command of the communication block 95 for “Home page” is “go to page 0”, step 406 is executed, and the new “target page code” is “0”. Therefore, the target page reminding display 35a displays “0”, and the user should turn to the communication card 90 for the “Home page”.

Although the present invention has been explained in relation to its preferred embodiment, it is to be understood that many other possible modifications and variations can be made without departing from the spirit and scope of the invention as hereinafter claimed.

What is claimed is:

1. An input device with a page turning functionality for use with a plurality of communication cards, each communication card corresponding to a page code, the input device comprising:
a casing having a control panel for accepting the plurality of communication cards;
a clip mechanism on the casing for clipping the communication cards together;
a processor;
a touchpad disposed on the control panel and below the plurality of communication cards;
a memory electrically connected to the processor, for storing a software program to be executed by the processor and audio information for a plurality of audio sounds;
a speaker for generating audio sounds according to the audio information; and
a target page reminding device electrically connected to the processor;
wherein at least one communication card includes a plurality of communication blocks, and when at least one of the communication blocks of one communication card is pressed, the processor generates a target page code signal and sends the target page code signal to the target page reminding device, the target page reminding device reminding a user to turn to the corresponding communication card according to the target page code signal.

2. The input device with a page turning functionality as claimed in claim 1, wherein the target page reminding device is a target page displaying device.

3. The input device with a page turning functionality as claimed in claim 1 further comprising a recognition device for detecting the current communication card to obtain the corresponding page code of the current displayed communication card.

4. The input device with a page turning functionality as claimed in claim 2 further comprising a recognition device for detecting the current communication card to obtain the corresponding page code of the current communication card.

5. The input device with a page turning functionality as claimed in claim 3, wherein if the user does not turn to the communication card corresponding to the target page code signal, the processor generates an error signal.

6. The input device with a page turning functionality as claimed in claim 5, wherein the speaker generates an error audio sound according to the error signal.

7. The input device with a page turning functionality as claimed in claim 5, wherein the target page reminding device generates error reminding information according to the error signal.

8. The input device with a page turning functionality as claimed in claim 1, wherein if the user does not turn to the communication card corresponding to the target page code signal, the user can not use the current displayed communication card in a normal manner.

9. The input device with a page turning functionality as claimed in claim 3, wherein the target page reminding device reminds the user, if the user does not turn to the communication card corresponding to the target page code signal, and the processor generates an error signal.

10. The input device with a page turning functionality as claimed in claim 9, wherein the speaker generates an error audio sound according to the error signal.

11. The input device with a page turning functionality as claimed in claim 9, wherein the target page reminding device generates error reminding information according to the error signal.

12. The input device with a page turning functionality as claimed in claim 9, wherein if the user does not turn to the communication card corresponding to the target page code signal, the user can not use the currently displayed communication card in a normal manner.
